(19) United States
(12) Patent Application Publication
(10) Pub. No.: US 2010/0005677 A1
(43) Pub. Date: Jan. 14, 2010

(54) MEASURING DEVICE FOR LACROSSE HEADS AND RELATED METHOD

(75) Inventors: Richard J. Janisse, Windsor (CA); Thomas H. Burns, Royal Oak, MI (US); Joshua G. Schmidt, Royal Oak, MI (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: WARRIOR SPORTS, INC., Warren, MI (US)

(21) Appl. No.: 12/490,878

(22) Filed: Jun. 24, 2009

Related U.S. Application Data
(60) Provisional application No. 61/080,040, filed on Jul. 11, 2008.
(60) Provisional application No. 61/083,850, filed on Jul. 25, 2008.

(51) Int. Cl. G01B 1/00

(52) U.S. Cl. 33/562

(57) ABSTRACT

A device and method to measure the dimensions of the lacrosse head to determine compliance with NCAA lacrosse rules. The device includes a longitudinal member having a terminal end adapted to engage a lacrosse head, and at least one cross bar joined with and generally transverse to the longitudinal bar at one or more preselected distances from the terminal end. The cross bar can be configured to measure the width or other dimension of the lacrosse head at the preselected distances. The cross bar can include movable arms that extend and collapse relative to the longitudinal bar to alter the overall dimensions of the device and make it generally easier to transport by users. The method includes using the device to determine whether a head complies with dimensional specifications.

### CROSS-REFERENCE TO RELATED APPLICATIONS

This application claims benefit of U.S. Provisional Application No. 61/080,040, filed Jul. 11, 2008, and U.S. Provisional Application No. 61/083,850, filed Jul. 25, 2008, both of which are incorporated by reference herein.

### BACKGROUND OF THE INVENTION

The present invention relates generally to lacrosse equipment, and more particularly, to a device for measuring a lacrosse head to determine whether the head complies with dimensional specifications.

Conventional lacrosse heads typically include an open frame having a ball stop joined with the base, a pair of sidewalls that extend from the ball stop, and a scoop that connects the sidewalls, opposite the ball stop. The sidewalls generally include a lower portion, such as a lower rim, that defines multiple circular or elliptical string holes. A lacrosse net is strung to the lower rim via the string holes, around the back side of the frame, leaving the opposing, or front side, side of the frame open for catching or shooting a lacrosse ball.

With improvements in technology and manufacturing techniques, lacrosse heads have evolved significantly over the past several years. Improvements have been made to increase the durability of a lacrosse head, through the use of new head materials, and to improve a player's ability to shoot, pass and otherwise control a lacrosse ball, through new head designs.

In 2007, the National Collegiate Athletic Association (“NCAA”) Men's Lacrosse Committee began an investigation to address issues related to the dimensions of currently available lacrosse sticks. Many committee members, and persons of interest in the lacrosse community, believed that the lacrosse heads at that time did not allow the lacrosse ball to come out of the head easily enough. In their opinion, this promoted more slashing, cross-checking, or contact with a lacrosse stick in the game to attempt to dislodge a lacrosse ball from the lacrosse head. This, in turn, allegedly created potential safety concerns related to excessive stick contact.

To remedy, or at least partially alleviate, these concerns, the NCAA Men's Lacrosse Committee proposed rule changes, scheduled to go into effect in 2010 (“Rules”). Among other things, the Rules specify minimum and maximum dimensions for both the head, stick and handle. While the Rules are applicable to NCAA competition, many other lacrosse organizations, from local leagues, to high school leagues, to youth leagues, adopt the Rules, greatly increasing the effect of the Rules on the dimensional requirements of lacrosse equipment in other layers of competition.

One of the new proposed Rules, Rule 1.17, addresses the minimum dimensional requirements between various portions of the sidewalls measured at a specific distance from the throat, also referred to herein as the ball stop. This Rule is further detailed at Appendix IV, of the Crosse Specifications of the NCAA Lacrosse 2008 Men's Rules and Interpretations, which provides: “Beginning Jan. 1, 2010, measurements for the crosse shall include the following, in addition to current specifications:”

| Measurement | Minimum distance |
|---|---|
| from throat | between narrowest point |
| (inches) | of head |
| 1.25 | 3.0 (all measurements) |
| 3.0 | 3.0 (all measurements) |
| 5.0 | 4.0 on the front/3.5 on the |
| | back |
| Widest point | 6.5 on the front/6.0 on the |
| | back |

In addition, Rule 1.17 requires the length of the head be a minimum of 10 inches from the outside edge of the head to the beginning of the throat. Although the above requirements are proposed, it is contemplated that the minimum distance between the narrowest point of the head at a measurement of 5 inches from the throat may perhaps change to 3.5 inches on both the front and the back; and at the widest point, the minimum distance will be 6.0 inches on both the front and back of the lacrosse head.

Thus, under the proposed Rules, a men's lacrosse head must be a minimum width of 3 inches at a location 1.25 inches from the throat, a minimum width of 3.0 inches between sidewalls at a location 3.0 inches from the throat, a minimum width of 4.0 inches on the front and 3.5 inches on the back at a distance of 5 inches from the throat, and a minimum width of 6.5 inches on the front and 6.0 on the back at the widest point of the lacrosse stick. The 1.25, 3.0, 5.0 inch and other dimensions are measured from the molded or wooden throat/ball stop of the frame of the lacrosse head, and not from a stop constructed of foam that is joined with the throat.

These dimensional requirements of the Rules allegedly prevent a player from using a stick that unfairly protects a ball within the pocket of the lacrosse head, thereby making it more difficult for an opponent to free the ball from the pocket. As an example, a lacrosse head with a width near its base that is only slightly larger than the diameter of the ball can provide an advantage in that it retains the ball in the pocket better than a head with a wider area near the base.

Ensuring that a lacrosse head complies with the dimensional requirements of the Rules will be difficult, particularly because a measurer or official will have to take multiple measurements at once. For example, to verify the 3.0 minimum width requirement, a measurer will first measure 3.0 inches above the throat, and then simultaneously measure across the width of the head on a line that is perpendicular to the 3.0 inch measurement. To take this measurement, the official will have to hold two rulers together perpendicularly and joined at a precise location. This will be a difficult task. Such measurements also may require an official who is engaged in strenuous athletic activity to carry around two or more rulers. Because of this, many officials may simply guess whether a head complies with the Rules. Accordingly, many illegal heads may go unchecked, which may promote unfair play in the game of lacrosse.

### SUMMARY OF THE INVENTION

A device and method are provided to measure the dimensions of a lacrosse head. The device includes a longitudinal bar having a terminal end adapted to engage a throat of a lacrosse head, and at least one cross bar joined with and generally transverse to the longitudinal bar at one or more preselected distances from the terminal end. The cross bar can be configured to measure the width or other dimension of the lacrosse head at the preselected distances from the throat. Optionally, the cross bar can be generally perpendicular to the longitudinal bar.

In one embodiment, multiple cross bars can be positioned at different distances from the terminal end of the longitudinal bar to measure dimensions of the lacrosse head as prescribed by the Rules.

In another embodiment, first and second lateral cross bars are joined with and transverse to the longitudinal bar. The second lateral cross bar can be located at a distance farther from the terminal end of the longitudinal bar than a first cross bar is positioned from the terminal end of the longitudinal bar. Optionally, the first bar is positioned 1.25 inches from the terminal end, and when measured from end-to-end, is 3.0 inches. Further optionally, the second cross bar is positioned at 3 inches from the terminal end, and when measured from end-to-end, is 3.0 inches.

In yet another embodiment, the device includes a third cross bar that is joined with and transverse to the longitudinal bar at a distance farther from the terminal end of the longitudinal bar than both the first and second cross bars. This third cross bar can be at a distance of about 5.0 inches from the terminal end and dimensioned to be about 4 inches from end-to-end.

In a further embodiment, the longitudinal bar can extend beyond the third cross bar a preselected distance. This distance may be selected so that the total length of the bar from the first terminal end to a second terminal end opposite the first terminal end is at least about 10 inches in total length.

In still a further embodiment, the longitudinal bar can include indicia indicating a distance of 10 inches from the first terminal end for use in measuring the length of the lacrosse head to determine compliance with the Rules. Optionally, the longitudinal bar can define a window through which the head can be viewed, with the indicia being located adjacent the window to confirm dimensional compliance.

In yet a further embodiment, the device can include a slidable fourth cross bar that is joined with, but slidable relative to, the portion of the longitudinal bar extending beyond the cross bars. The fourth transverse cross bar can be dimensioned so that from one end to the other its width is about 6.0 inches so that it can measure the widest point of the lacrosse head.

In still another embodiment, the longitudinal bar can include indicia indicating a distance of 6.0 inches from the first terminal end for use in measuring the widest point of the lacrosse head to determine compliance with the Rules. Optionally, the longitudinal bar can define a window through which the head can be viewed, with the indicia being located adjacent the window to confirm dimensional compliance.

In another further embodiment, each of the first, second, third and fourth cross bars can be partitioned into independent arms or portions. For example, the first transverse cross bar can include a first arm and a second arm. The first arm and second arm can each be hingedly or pivotally joined with the longitudinal bar, and positionable in both a retracted position and an extended position. In a retracted position, each of the arms can lay adjacent the longitudinal bar, generally aligned with the length of the bar, and optionally within a periphery of the longitudinal bar. In the extended position, each of the arms can extend generally perpendicularly from the longitudinal bar. Optionally, the collective length of the first arm, second arm and width of the longitudinal bar between the arms is less than or equals the dimension desired to be measured on the lacrosse head.

For example, the first bar can include first and second arms or portions, which, when extended relative to the longitudinal cross bar, are of a dimension so that the total distance from a first end of one arm to a second end of the opposite arm is 3.0 inches.

In yet another further embodiment, the terminal end of the longitudinal bar can be configured as a semicircle, a triangular point, or an arc so that it can engage the throat of a lacrosse head at a point that is dead center of the throat (also referred to as a ball stop). Optionally, the terminal end can include a contact portion that extends upward or downward from the longitudinal bar, and that is designed to engage the ball stop or throat of the head during measurement. Further optionally, the terminal end of the bar can be configured to engage multiple points on the ball stop and/or sidewalls so that the longitudinal bar is centered along the longitudinal axis of the head and capable of measuring desired distances between the throat/ball stop and other points on the lacrosse head.

In yet another, further embodiment, the portion of the longitudinal bar extending between the third transverse cross bar and the second terminal end of the longitudinal bar can be void of any markings that denote distances from the terminal end or other portions of the device.

In yet another embodiment, the first, second and third cross bars of the device can be fixedly joined with the longitudinal bar, and the longitudinal bar and/or a cross member can include protrusions extending from a top or bottom surface of the device. These protrusions can be set apart from one another, or of a length corresponding to a dimension desirable to measure on the lacrosse head. For example, one protrusion can be positioned on a top side of the third transverse cross bar and can and include a first end and a second end, the first end and second end separated from one another by 3.5 inches. This protrusion can be used to measure a 3.5 inch dimension of the lacrosse head.

In yet a further embodiment, a method for using the device is provided in which the first terminal end of the longitudinal bar can be positioned with the terminal end engaging the throat/ball stop of the head, the longitudinal bar generally aligned along the axis of the head. The first, second, third and optional fourth transverse cross bars can be aligned with widths of the lacrosse head desired to be measured. Where the cross bar barely contacts, or does not contact, the sidewalls of the lacrosse head, a user can determine that the stick head is legal.

In yet another further embodiment, where the device includes collapsible arms, the user can position each of the arms in an extended mode before measuring the dimensions of the lacrosse head. This can be done manually or semi-automatically via a mechanism that extends the arms when the user engages the mechanism. Further, where the device includes a fourth transverse cross bar that is slidable relative to the longitudinal bar, the user can move the fourth transverse bar generally longitudinally along the axis of the longitudinal bar. The user can slide the fourth transverse cross bar toward or away from the first terminal end to determine whether the minimum distance between opposing sidewalls or between opposing portions of the scoop of the lacrosse head satisfy minimum dimension requirements.

Even further optionally, where the device includes indicia or projections to measure certain dimensions perpendicular to the longitudinal axis of the lacrosse head, the device can be rotated relative to the axis of the head so that the indicia or protrusions properly align with the dimension to be measured.

The device and method described herein enable lacrosse officials and others to quickly and accurately measure the dimensions of a lacrosse head. Where the device includes collapsible portions, the device is quickly and easily convertible to a configuration that can be carried by a game official in a pocket or elsewhere.

These and other objects, advantages, and features of the invention will be more fully understood and appreciated by reference to the description of the current embodiment and the drawings.

### BRIEF DESCRIPTION OF THE DRAWINGS

FIG. 1 is a front view of a lacrosse head of the prior art;

FIG. 2 is a rear view of the lacrosse head of the prior art;

FIG. 3 is a top view of a device of a current embodiment being used to measure certain dimensions on the front of the lacrosse head;

FIG. 4 is a top view of the device being used to measure other dimensions on the rear of the lacrosse head;

FIG. 5 is a perspective view of the device;

FIG. 6 is a perspective view of the device being configured to a closed mode;

FIG. 7 is a first alternative embodiment of the device;

FIG. 8 is a second alternative embodiment of the device;

FIG. 9 is a third alternative embodiment of the device; and

FIG. 10 is a fourth alternative embodiment of the device.

### DESCRIPTION OF THE CURRENT EMBODIMENT

### I. Lacrosse Heads

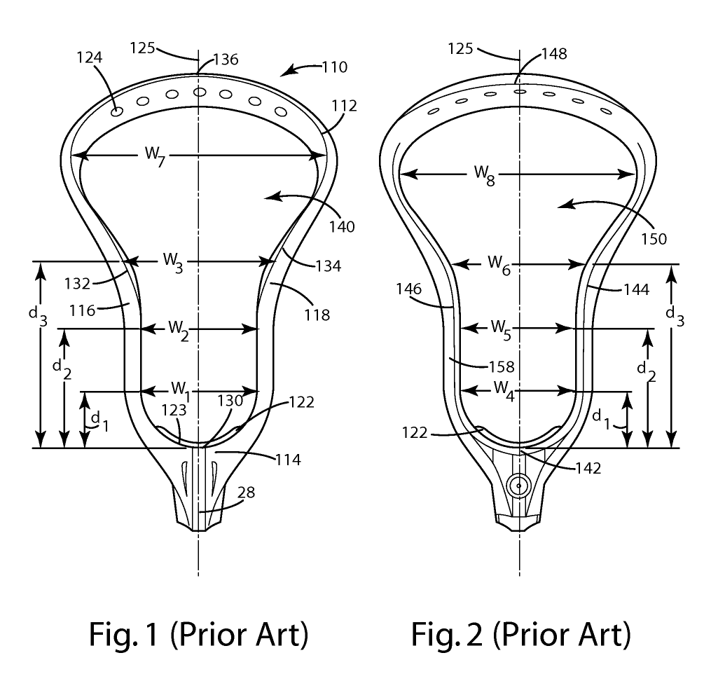

As shown in FIGS. 1 and 2, a conventional, prior art lacrosse head 110 has a frame 112, which includes a throat or ball stop 114, a pair of opposing sidewalls 116, 118, and a scoop 120 joining the pair of opposing sidewalls 116, 118 opposite the throat 114. The throat 114 may include a separate foam element 122 joined with its inner surface 123.

The frame 112 also can define net securing structures 124 to enable attachment of the netting (not shown) to the head. The lacrosse head 110 can define a socket 128 that extends generally rearward from the throat 114 of the frame 112 for attachment of a handle (not shown) or element.

As shown in FIG. 1, the upper rim 130 of the throat 114 and the upper rims 132, 134 of the sidewalls 116, 118, with the top 136 of the scoop 120, define a ball receiving area 140. The ball receiving area 140 is functionally the portion of the head 110 where the lacrosse ball can enter or exit the head 110 when caught, thrown, shot, thrown or dislodged.

As shown in FIG. 2 the lower rim 142 of the throat 114 and the lower rims 144, 146 of the sidewalls 116, 118, with the bottom 148 of the scoop 120, define a ball retention area 150. The ball retention area 150 is functionally the portion of the head 110 where the lacrosse ball is typically retained in the head 110 and where the netting is generally attached to the head 110.

In general, the upper rims 132, 134 define the uppermost surfaces of the sidewalls 116, 118, while the lower rims 144, 146 define the lowermost surface of the sidewalls 116, 118. Optionally, the upper rims 132, 134 and lower rims 144, 146 may be a single integral structure, or may be rails separated by apertures.

The frame element 112 described herein is merely illustrative of known lacrosse heads 110 for use in describing the lacrosse head measurement devices in accordance with the current embodiments below.

### II. Overview

A current embodiment of the lacrosse head measuring device of the present invention is shown in FIG. 1 and generally designated 10. The device as shown includes a longitudinal member (also referred to as a bar or element), a first transverse cross bar 30, a second transverse cross bar 40 and a third transverse cross bar 50, each joined with the longitudinal bar 20. Each of the cross bars 30, 40 and 50 can be positioned a selected distance from the first terminal end 13 of the longitudinal bar 20 to measure widths of the lacrosse head at specific locations. Each of the cross bars also can be segmented into portions or arms that are foldable relative to the longitudinal bar 20 so that they may be pivoted or otherwise moved to reduce the overall dimensions of the device 10, thereby making it easier to carry.

The longitudinal bar 20 can also include indicia indicating a specified distance from first terminal end 13 to the indicia so that the device 10 can be used to measure the minimum overall length of a lacrosse head from the ball stop, which under current Rules, is 10 inches. Optionally, the longitudinal bar can define one or more windows 63, 64 with indicia 65, 66 adjacent the windows, so that a portion of the frame can be viewed through the window and compared against the indicia 65, 66 to determine compliance with dimensional specifications, such as those specified under the Rules. As illustrated, the indicia 65 indicates a distance of 6 inches or 6.5 inches and the indicia 66 indicates a distance of 10 inches from the first terminal end 13.

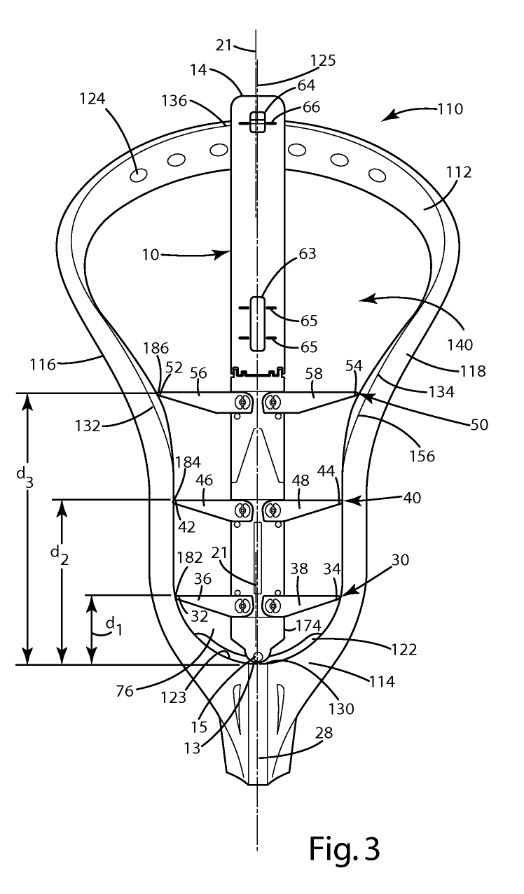

As shown in FIG. 3, the measuring device 10 can be inserted within the front side opening of a lacrosse head 110, with the first terminal end 13 configured to engage the throat or ball stop 114, at the upper rims, with the longitudinal bar axis 21 of the longitudinal bar 20 aligned with the axis 125 of the head 110, and the cross bars 30, 40 and 50 positioned at locations corresponding to dimensions prescribed by the Rules.

For example, the Rules specify the minimum dimensions between the inner surfaces of the sidewalls 116, 118 measured at a specific distances from the throat 114. With reference to FIGS. 1 and 2, at a distance d1 of 1.25 inches from the throat 114, as measured along a reference axis 125 extending from the throat 114 to the scoop 120 and equidistant from the sidewalls 116, 118, the minimum distance W1 between the inner surfaces of the upper rims 132, 134, and the minimum width W2 between the inner surfaces 156, 158 of the lower rims 144, 146, is 3 inches. The widths W1 and W2 are measured along reference lines that are perpendicular to reference axis 125. At a distance d2 of 3.0 inches from the throat 114, the minimum distance W3 between the inner surfaces of the upper rims 132, 134, and the minimum distance W4 inner surfaces 158 of the lower rims 144, 146 is also 3 inches. The widths W3 and W4 are measured along reference lines that are perpendicular to reference axis 125. At a distance d3 of 5.0 inches from the throat, the minimum width W5 is 4.0 inches between the upper rims 132, 134 and a minimum width W6 of 3.5 inches between the lower rims 144, 146, as measured between their respective inner surfaces 156, 158. The widths W5 and W6 are measured along reference lines that are perpendicular to reference axis 125. Finally, the minimum width W7, W8 at the widest point between the sidewalls 116, 118 is 6.5 inches measured between the inner surfaces 156 of the upper rims 132, 134 6.0 inches measured between the inner surfaces 158 of the lower rims 144, 146. The width W7 and W8 are measured along reference lines that are perpendicular to reference axis 125.

The lacrosse head measuring device of the current embodiments can quickly and easily assist a user in determining whether a lacrosse head is compliant with all, or a portion of, the proposed dimensional width and length requirements of the Rules, or other specifications as desired.

As used herein, the term “bar” refers to any generally elongate member or element that spans a distance from one end to the other. A bar can be segmented into different portions, and those portions can be fixed or moveable relative to one another or to other bars or other components of the device, such as the longitudinal bar.

As used herein, the term “Rules” refers to the current or proposed rules regarding dimensions of lacrosse head mandated by the NCAA, where the proposed Rules are scheduled to become effective Jan. 1, 2010. The Rules are incorporated by reference in their entirety herein.

### III. Construction

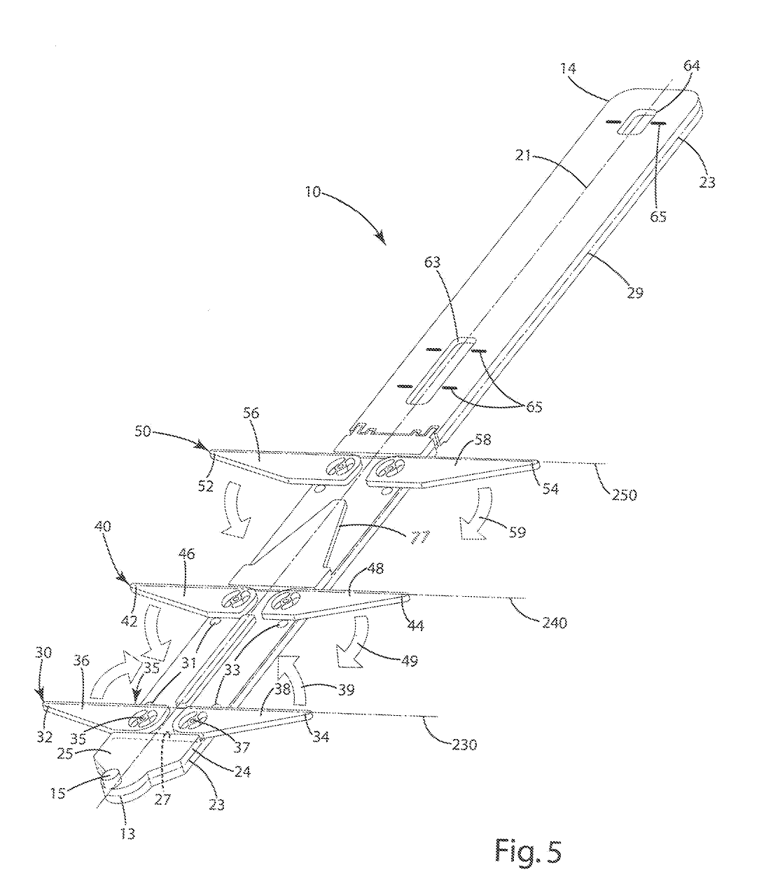

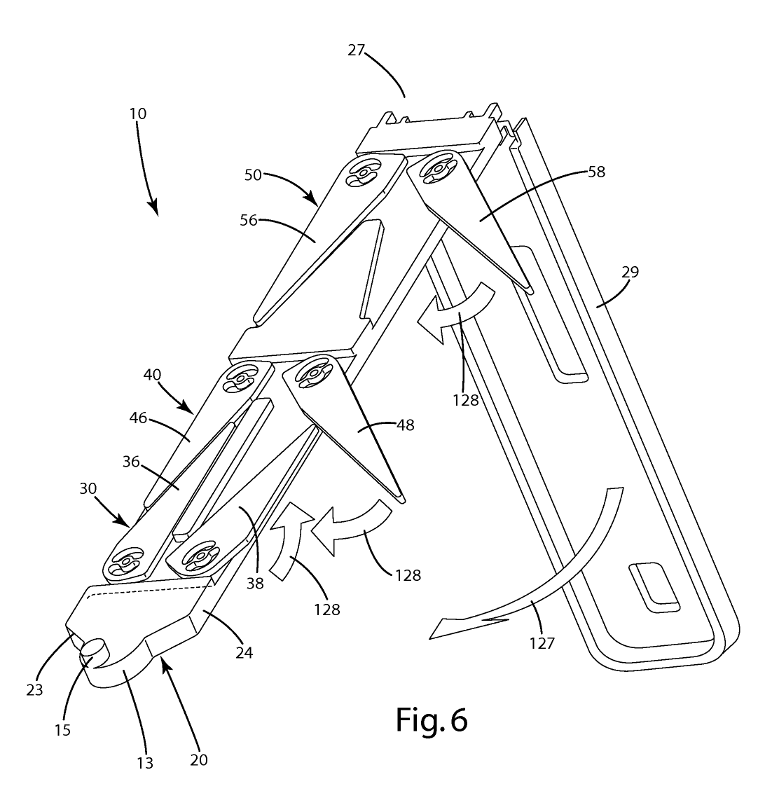

With reference to FIGS. 3-6, one embodiment of the measuring device will be described in more detail. The device 10 includes a longitudinal bar 20 having a first terminal end 13 and a second terminal end 14. The first terminal end 13 can be of a rounded or semicircular shape; however, any other geometric shape can be substituted for this shape as desired. For example, the first terminal end 13 can be of a sharply pointed, triangular shape, a pointed shape having curved sides leading to a point, or a long narrow shape. The second terminal end 14 can likewise be of similar geometric shapes. Optionally, the first terminal end 13 can include a reference post 15 which extends upward and/or downward relative to the longitudinal bar 20. The post 15, shown best in FIGS. 5 and 6, can be of a cylindrical, box-like or other geometric shape as desired.

Generally, the shape of the first terminal end 13 can be such that it decreases in width as it extends toward the end. This decreasing width configuration enables the device 10 to be positioned adjacent the throat 114 of the lacrosse head without interfering with the remainder of the throat 114, the foam stop 122, or sidewalls 116. Optionally, the decreasing width or the reference post 15 can compress the foam stop 122 so that the first terminal end 13 engages the throat 114 to provide accurate measurements. More generally, the first terminal end 13 can be somewhat pointed so that it enables an official to compress a foam stop, which is regularly found on most lacrosse heads, so that the actual measurement can be taken from the plastic frame of the throat 114, rather than offset by the depth of the foam stop.

As shown in FIGS. 3-6, the device 10 can include one or more transverse bars 30, 40, 50 joined with the longitudinal member 20. The first transverse cross bar 30 can include opposing first and second ends 32 and 34. These first and second ends 32 and 34 can be joined with and form a terminal points of the first transverse cross bar arms or portions 36 and 38. The ends 32 and 34 can be pointed as shown, or of any other geometric configuration, such as those described in connection with the first terminal end 13 of the longitudinal bar 20 above. The illustrated arms 36 and 38 can be configured to move relative to the longitudinal bar 20, as explained further below, or can be stationary, and integrally formed with the longitudinal bar. The ends 32 and 34 of the first transverse cross bar can be separated by about 3.0 inches, and can be configured to measure the width W1 and W4 between opposing portions of a lacrosse head 100 at distance d₁ with reference to FIGS. 1-3. Of course, the ends can be separated by other distances as desired.

The second transverse cross bar 40 can include opposing third and fourth ends 42 and 44. These third and fourth ends 42 and 44 can be joined with and form terminal points of the second transverse cross bar arms or portions 46 and 48. The ends 42 and 44 can be pointed as shown, or of any other geometric configuration, such as those described in connection with the first terminal end 13 of the longitudinal bar 20 above. The illustrated arms 46 and 48 can be configured to move relative to the longitudinal bar 20, as explained further below, or can be stationary, and integrally formed with the longitudinal bar. The ends 42 and 44 of the second transverse cross bar can be separated by about 3.0 inches, and can be configured to measure the widths W2 and W5 between opposing portions of a lacrosse head 100 at distance d2, with reference to FIGS. 1-3. Of course, the ends can be separated by other distances as desired.

The third transverse cross bar 50 can include opposing fifth and sixth ends 52 and 54. These fifth and sixth ends 52 and 54 can be joined with and form a terminal points of the third transverse cross bar arms or portions 56 and 58. The ends 52 and 54 can be pointed as shown, or of any other geometric configuration, such as those described in connection with the first terminal end 13 of the longitudinal bar 20 above. The illustrated arms 56 and 58 can be configured to move relative to the longitudinal bar 20, as explained further below, or can be stationary, and integrally formed with the longitudinal bar. The ends 52 and 54 of the third transverse bar can be separated about 3.5 inches or about 4.0 inches, and configured to measure the widths W3 and/or W6 between opposing portions of a lacrosse head 100 at distance d3, with reference to FIGS. 1-3. Of course, the ends can be separated by other distances as desired.

The transverse cross bars can be movable so that the device may be operable in both an extended mode and a collapsed mode. Generally, in the extended mode, all of the arms 36, 38, 46, 48, 56, 58 are extended so that the device 10 can be used to measure or evaluate the dimensions of a lacrosse head 110 as shown in FIG. 3. In the collapse mode, the arms 36, 38, 46, 48, 56, 58 are collapsed in the direction of the arrows 39, 49, 59 so that the arms lie generally within the outer periphery 23 defined by the longitudinal member (FIG. 5).

Generally, when extended, each of the transverse cross bars 34, 40 and 50 can lie on respective transverse axes 230, 240 and 250 which are perpendicular to longitudinal member axis 21 at 1.25, 3.0 and 5 inches from the first terminal end 13, respectively. Of course, these transverse axes can lie at different distances from the first terminal end as desired.

Optionally, the position and dimension of the transverse cross bars 30, 40 and 50 can be altered depending on the particular Rules for which the measuring device 10 is designed, for example, men's lacrosse rules, women's lacrosse rules and other competitive rules.

Optionally, the actual dimensions of the cross bars 30, 40, 50 can include a portion of the longitudinal member. For example, with reference to FIG. 5, the total width of the transverse cross bar 30 can include the length of the arms 36 and 38, as well as a portion of the width of the longitudinal bar 20. Optionally, the first and second arms 36 and 38 can be generally of equal length and project the same distance on opposite sides of the longitudinal member axis 21 as desired. For example, the arm 36 can extend about 1 inch outward from the longitudinal bar, the second arm 38 can extend about 1 inch on the other side of the bar 20, while the longitudinal bar 20 itself can add about one inch to the collective overall measurement from the first end 32 to the second end 34. The other bars 40 and 50 can be configured in a similar manner depending on the respective dimensions that are the bars are designed to measure.

FIGS. 5 and 6 also show an optional moveable configuration for the arrows of the cross bars. For example, the arms 36 and 38 can be joined with respective pins 35 and 37 to the longitudinal member 20. These pins 35 and 37 can include resilient arm portions with an enlarged head (not shown). The longitudinal member 20 can define corresponding holes (not shown). The pins 35 and 37 can be inserted through the respective holes until the resilient arms snap fit the enlarged head in the hole to pivotally join the arms 36 and 38 to the longitudinal member 20. The other arms 40 and 50 can include similar connections. Of course, the arms 30, 40 and 50 can be connected to the longitudinal member 20 in any manner that provides rotational or pivoting or other movement so that the arms can be collapsed from an extended mode to reduce the overall dimensions of the device to make the device easier for transport and/or storage.

Referring further to FIGS. 5 and 6, the arms 36 and 38, generally extend in opposite sides of the longitudinal axis 21 of the longitudinal bar 20. The arms can be biased in place by springs (not shown) engaging the longitudinal member 20 and the respective arms. The arms can also be held in place via detents or protrusions 31 and 33 extending from the longitudinal bar 20.

As shown in FIG. 5, the rotation of the arms 36 and 38 can be limited when those arms 36 and 38 engage the stop surfaces 27, which can generally be a raised portion of the longitudinal member adjacent the arm. Other features, such as protrusion 77, may be incorporated into the longitudinal member to limit the rotation of the arms of the respective cross bars.

The cross bars 30, 40 and 50, when pivotable or movable relative to the longitudinal member 20, can be positioned generally on a front side 25 of the longitudinal bar 20. If desired, the cross bars 30, 40 and 50 can be positioned inside a cavity (not shown) defined by the longitudinal bar so that the pivot points of the respective arms are protected from the environment. Optionally, the cross bars 30, 40 and 50 can be staggered on opposite front and rear surfaces of the longitudinal bar 20 as desired.

With reference to FIGS. 5 and 6, the longitudinal member 20 can be subdivided into first and second longitudinal member parts or portions 24 and 29. These members or portions of the longitudinal bar can be joined together at a hinge 27, which is of conventional construction. If desired, the hinge can be substituted with a pivot pin (not shown). In general, the hinge or the pivot pin can enable the first part 24 and second part 29 to move relative to one another so that the longitudinal bar itself can reconfigured from an extended mode to a collapsed mode. In the collapsed mode, the overall dimensions of the device can be diminished, in some cases, by half the longitudinal length of the member. Accordingly, a user can easily place the device in a pocket when the device is collapsed the reduced dimensions of the device relative to the extended mode.

FIG. 6 illustrates with arrow 127 how the second part 29 can be folded about the hinge 27 toward the first part 24. Alternatively, the second member 29 can be slidable relative to the first member 24 of the longitudinal bar, with the first member 24 defining a compartment into which the second member can slide to reduce the overall dimension (not shown). Any other construction to reduce the dimensions of the longitudinal bar can be used as desired.

The longitudinal bar can also define windows 63 and 64 beyond the transverse cross members 30, 40 and/or 50. The window 63 can be configured so that the user can peer entirely through the longitudinal member 20, and see a portion of the lacrosse head 110 when conducting measurements. The other window 64 likewise can be configured. Adjacent the windows, indicia 65 and 66 can be located. The indicia 65 can indicate distances of 6 inches and/or 6.5 inches from the terminal end 13 to comply with the Rules, while the indicia 65 can indicate a distance of 10 inches from the terminal end 13 to measure a minimal length of the head as prescribed by the Rules.

Optionally, the longitudinal member 20 can be void any windows, and the respective indicia for different dimensional requirements can be positioned adjacent the sides of the longitudinal bar so that the bar can be used much like a ruler. Further optionally, the windows can be filled with a clear material or a portion of the longitudinal bar near the second terminal end 14 of the longitudinal bar can be transparent, with the appropriate measurement indicia marked across the clear material to take desired measurements.

The device 10 and its various components can be constructed from a solid steel or aluminum plate, or optionally from synthetic materials such as plastic. Other suitable materials are those which do not expand or contract due to temperature change. One possible material is a polycarbonate such as LEXAN®. The depth of the device can be about ⅛ inch, ¼ inch, ½ inch, 1 inch, or greater, or less, depending on the application.

### IV. Method of Manufacture and Use

The manufacture and use of the measuring device of the current embodiment will now be described. The device 10 can be molded or extruded from a plastic or other synthetic material in the desired shape.

More particularly, the longitudinal member 20 and the other components, for example, the cross members and respective arms or portions of those cross members 30, 40 and 50 can be molded from a plastic material, for example, polycarbonate. The components can be molded in the desired configuration. After the components are molded, they can be assembled. For example, each of the independent arms of the embodiment shown in FIGS. 5 and 6 can be joined with the longitudinal member 20. The arms can be inspected to ensure that they rotate in the directions of the arrows as illustrated.

Where the longitudinal member 20 optionally includes first and second parts 24 and 29, those parts can be joined together at the hinge 27 or other connection element as desired. The components of the device 10 can be marked with indicia using screen printing or other processes as desired to indicate the respective measuring dimensions. With the device assembled and including the appropriate indicia and/or other markings, the device 10 can be folded to the completely collapsed mode as indicated in FIG. 6, and further packaged for distribution.

In other embodiments, where the device 10 is constructed from a sheet of steel or aluminum or other metal, or some other synthetic material (such a fiberglass, plastic or carbon), the device can be machined or cut from that material. The machining or cutting results in the components of the device being configured as desired. Further assembly can be performed to complete the device 10. Optionally, after the device 10 is manufactured, the it can be drilled with multiple holes to remove excess material and reduce weight even further.

In operation, the device is generally retrieved from a storage location, for example, a user's pocket or a storage compartment. The device, when stored, is typically stored in the collapsed mode. Thus, the user will convert the device 10 from the collapsed mode to the extended mode, in which the components of the device are moved in the opposite direction of the arrows 127 and 128 in FIG. 6. While the precise sequence of moving the components of the device 10 may vary, one example of a sequence to move the components from the collapsed mode to the extended mode includes extending the first and second portions 36 and 38 of the first cross bar 30 from a collapsed mode, wherein the arms are generally within the outer periphery 23 of the longitudinal member 20, to the extended mode, where the arms 36 and 38 and ends 34, 36, generally lie on the transverse axis 230 (FIG. 5). The third and fourth portions 46 and 48 of the second cross bar 40, as well as the fifth 56 and sixth 58 portions of the third cross bar, are likewise moved from a collapsed mode to an extended mode. Where included, the second part 29 of the longitudinal bar 20 is folded away from the first part 24 of the longitudinal bar opposite the direction 127 indicated by the arrow 127 in FIG. 6. In general, the second part is extended until it is generally co-planar with the first part 24. If a locking mechanism is included, it may be engaged to hold the first and second parts in a generally planar configuration relative to one another. The first terminal end 13, and where included, the reference post 15, is positioned adjacent the lacrosse head 110. When measuring the dimensions of the upper most surfaces of the sidewalls 116, 118, for example, the ball receiving area 140 (FIG. 3), the reference post 15 of the terminal end 13 is positioned in contact with the throat 114. The longitudinal axis 21 of the longitudinal bar is positioned parallel and generally aligned with the longitudinal axis 125 of the lacrosse head. Due to the locations and dimensions of the cross bars 30, 40 and 50, those bars align with the sidewalls so the user can check the dimensions of the lacrosse head 110 against different dimensional specifications as required by the Rules or other governing requirements in multiple locations, for example at D₁, D₂ and D₃ (FIG. 1), to confirm compliance with the specific dimensional specifications.

For example, in the embodiment shown in FIG. 3, the device is inserted in the opening of the ball receiving area 140 of a lacrosse frame 112, with the opposing ends 32, 34; 42, 44; 52, 54 slightly contacting, immediately adjacent, but optionally, not contacting the respective sidewalls 116, 118 as the application and dimensions specify. If the measuring device 10 does not fit within the ball receiving area 140 or the respective cross bars 30, 40 and 50 do not fit between the sidewalls, then the head is likely illegal. If the device and its respective components fit between the respective portions of the head, then the device is likely legal under the dimensional requirements of the Rules or other measuring specifications.

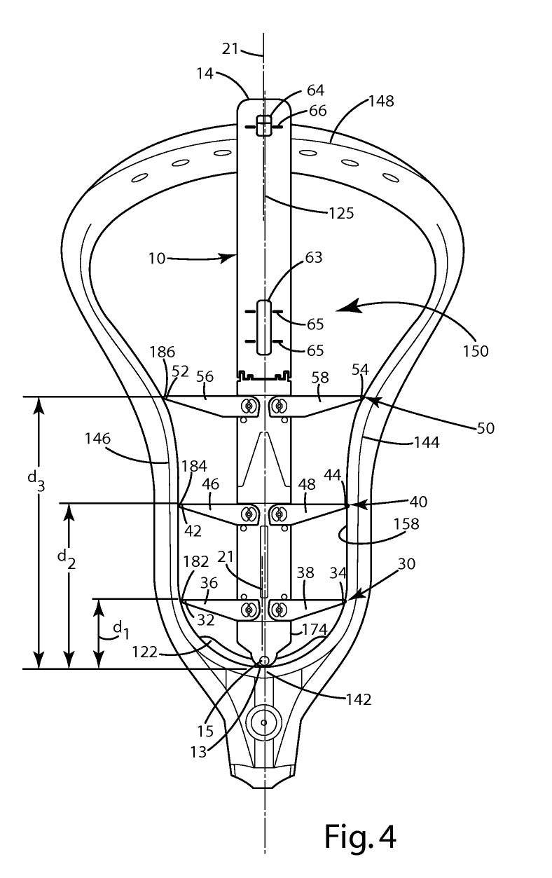

If the user desires to measure the ball receiving area of the head to ensure compliance with other dimensional requirements of the Rules, then the user can move the device 10 to the ball retaining area and align the different components as illustrated in FIG. 4. The user can then perform the same comparison to determine compliance or non-compliance with the dimensional requirements with the rear of the head.

Where the device includes windows 63 and 64, the indicia 66 can be referenced against the top of the lacrosse head to determine whether or not the head complies with the minimum measurement of 10 inches, as required by the Rules. For example, the user views the frame element 112 through the window 64 and compares the boundary of the frame element 112 within the window relative to the indicia 66. Depending on the prescribed Rules, the user can determine whether or not the head is in compliance or not in compliance with the dimension specifications.

Where the device 10 includes the optional window 63 and other indicia 65 for other measurements, the device can be used to measure or determine compliance with other dimensions of the Rules. For example, a user can determine the minimum width of the ball receiving area and the ball retaining area by placing the reference post 15 and/or the terminal end 13 against the sidewall, with the longitudinal axis 21 generally transverse, and more specifically, perpendicular to, the longitudinal axis 125 of the lacrosse head 110. The user then views the frame element 112 through the window 63 and determines where the inner surface of the ball retaining area falls relative to the respective indicia 65. In this manner, the user can measure front of the head 110 to determine whether the minimum width of the ball receiving area is 6.5 inches as provided by the Rules. To check the ball retaining area, the user can move the device 10 to the opposite (rear) side of the head 110 as shown in FIG. 4, and perform the same measurement to determine whether or not the head ball retaining area has a minimum dimension of 6 inches as provided by the Rules.

### V. Alternative Embodiments

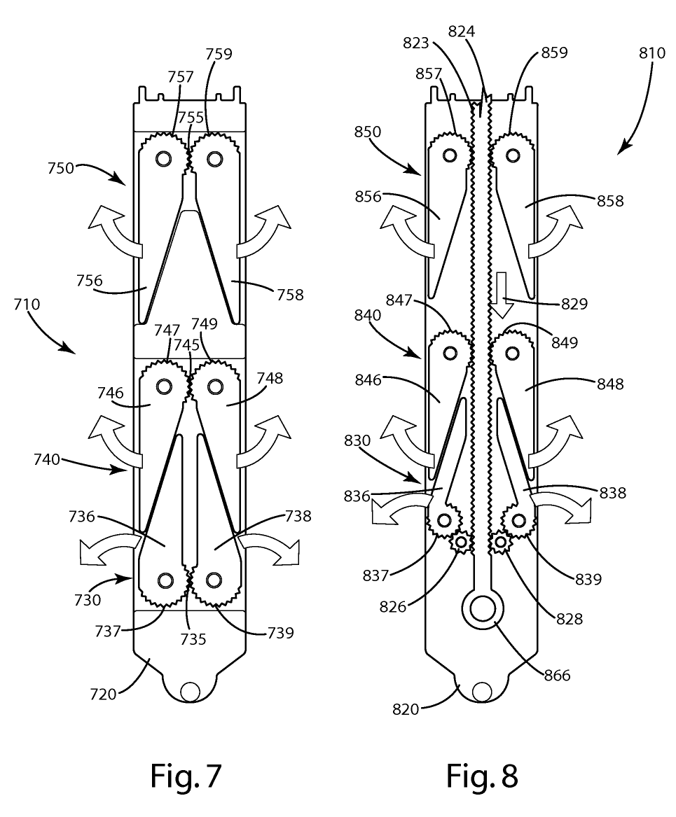

As shown in FIG. 7, a first alternative embodiment 710 of the measuring device is shown. There, the transverse cross bars 730, 740, 750 are modified so that movement of one of the respective arms of each cross bar results in movement of the other arm or portion of the same cross bar. For example, moving the arm 756 in the direction shown by the arrow 777 simultaneously moves the arm 758 in the direction of the respective arrow on the other side of the device, from a collapsed mode to an extended mode. The same is true for arm 746 and 748, as well as 736 and 738.

The arms are coupled to one another with a movement transferring mechanism 755, 745 and 735. As illustrated, those mechanisms are generally geared or tooth portions of the respective inner portions of the respective transverse cross bars. The gears mesh with one another so that movement of one arm results in corresponding movement of the other arm from a collapsed mode to an extended mode, or vice versa. Of course, different mechanisms may be substituted for those shown in FIG. 7 as desired to provide simultaneous movement of the arms of each cross bar.

FIG. 8 shows a second alternative embodiment 810 of the measuring device, which employs a rack and pinion gear to simultaneously move the transverse cross bars 830, 840 and 850 from a collapsed mode to an extended mode and vice versa. More particularly, a user engages the control end 866 of the rack gear 824 and moves it in direction 829. This movement causes the respective arms of each of the cross bars 830, 840 and 850 to move from the collapsed mode illustrated in the directions of the respective arrows to an extended mode, readied for measurement.

In general, the rack gear 824 includes geared surfaces 823 and 825 which directly and indirectly engage the respective gears 857 and 859; 847 and 849; and 837 and 839 of the respective cross bars 850, 840 and 830.

With the first transverse cross bar 830, the movement of the respective bars 836 and 838 is generally opposite of the movement of the rack gear 824. Accordingly, counter gears 826 and 828 are interposed between the rack gears 823 and 825, and the respective gears 837 and 839 on the arms 836 and 838. Accordingly, the movement 829 translates to the movement shown by the arrows adjacent the arms 836 and 838. The measuring device can be reconfigured from the extended mode to the collapsed mode simply by reversing movement of the rack gear 824. Other mechanisms may be substituted for the rack gear to simultaneously move all the arms of the respective cross bar as desired.

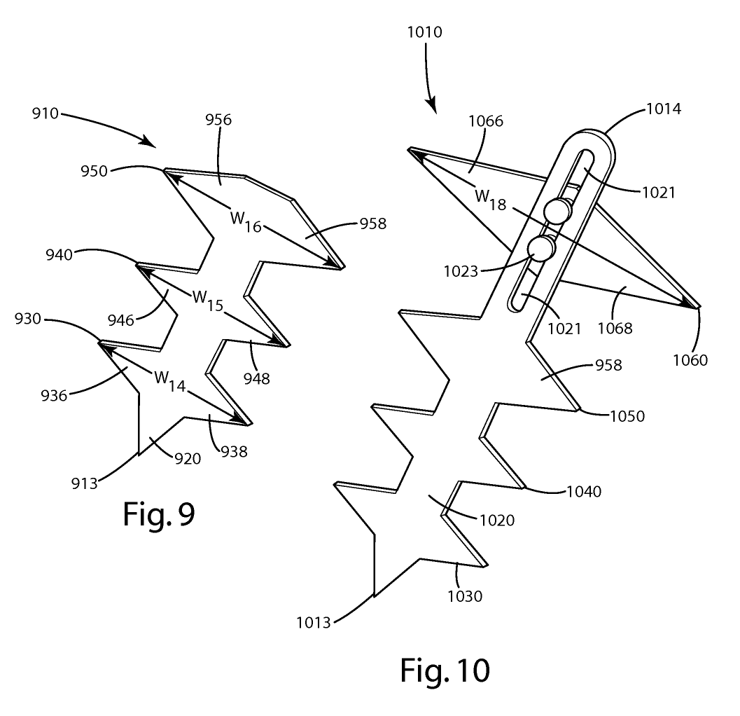

With reference to FIG. 9, a third alternative embodiment of the measuring device 910 is illustrated. There, the cross bars 930, 940 and 950 are generally integral with the longitudinal bar 920. The respective arms 956, 958; 946, 948; and 936, 938 of the bars are generally immovable and/or stationary relative to one another and to the longitudinal bar 920. Each of the respective bars terminates at pointed ends, with widths W14, W15 and W16 separating the ends of the bars. The ends and the respective widths W14, W15 and W16 can correspond to the minimum dimensional requirements as provided in the Rules or by other specifications. The device 910 can be utilized in a similar manner to that of the embodiment described above by placing it within the lacrosse frame 112 (FIG. 1). If desired, a set of two of the measuring devices 910 can be provided, one for measuring the minimum dimensions of a lacrosse head in the ball receiving portion (FIG. 1) and another for measuring the dimensions in a ball retaining area (FIG. 2) of the lacrosse head.

A fourth embodiment of the device, shown in FIG. 10, is similar to that of the third alternative embodiment of FIG. 9, however, the device also includes a second portion of the longitudinal member 1020 that extends beyond the cross bars 1030, 1040 and 1050. This portion defines a slot 1021. A fourth transverse cross bar 1066 is joined with the slot via receiving pins 1023. The pins are journaled in the slot 1021 and enable the cross bar 1060 to slide relative to the longitudinal bar 1020.

The cross bar 1060 of this alternative embodiment can be 6.5 inches or some other length, and can be used to ensure compliance to determine whether or not a particular head complies with a minimum width of 6.5 inches on the front of the lacrosse and 6 inches on the back of the lacrosse head, or any other dimension. As described in the embodiments above, the fourth cross bar 1060 is moved upward and downward (toward or away from the throat of the head). As long as the width of the respective ball receiving portion and ball retaining portion (adjacent the cross bar 1060 as it moves) are greater than the width W18 of the device 1010, then the head is compliant with the respective portion of the Rules. As desired, other mechanisms may be used to join the fourth cross bar 1060 with the longitudinal bar 1020 and provide the desired movement of it relative to the bar 1020.

The above description is that of the current embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

1. A lacrosse head measurement device adapted to measure a lacrosse head having a throat, a scoop, a pair of opposing sidewalls, and a lacrosse head longitudinal axis, wherein an upper rim of the throat, the scoop and the pair of opposing sidewalls define a ball receiving portion, and wherein a lower rim of the throat, the scoop and the pair of opposing sidewalls define a ball retaining portion, the device comprising:
a longitudinal member including a longitudinal member longitudinal axis and a first terminal end adapted to contact the throat of the lacrosse head, the longitudinal member longitudinal axis adapted to align generally parallel to the lacrosse head longitudinal axis when the first terminal end contacts the throat of the lacrosse head, the longitudinal member defining an outer periphery,
a first cross bar including a first portion and a second portion, each moveably joined with the longitudinal member distal from the first terminal end, the first portion terminating at a first end, the second portion terminating at a second opposing end, the first portion and the second portion moveable from a collapsed mode to an extended mode, the first portion and the second portion being generally disposed at least partially within the outer periphery of the longitudinal member in the collapsed mode so as to reduce the overall dimensions of the device, the first portion and the second portion extending beyond the outer periphery of the longitudinal member in the extended mode, the first and the second ends laying on a first transverse axis that is perpendicular to the longitudinal member longitudinal axis 1.25 inches from the first terminal end, the first and second ends being 3 inches from one another in the extended mode; and
a second cross bar including a third portion and a fourth portion, each moveably joined with the longitudinal member distal from the first terminal end, the third portion terminating at a third end, the fourth portion terminating at a fourth opposing end, the third portion and the fourth portion moveable from a collapsed mode to an extended mode, the third portion and the fourth portion being generally disposed at least partially within the outer periphery of the longitudinal member in the collapsed mode so as to reduce the overall dimensions of the device, the third portion and the fourth portion extending beyond the outer periphery of the longitudinal member in the extended mode, the third and the fourth ends laying on a second transverse axis that is perpendicular to the longitudinal member longitudinal axis 3 inches from the first terminal end, the first and second ends being 3 inches from one another in the extended mode,
wherein the longitudinal member extends beyond the second cross bar and terminates at a second terminal end, the longitudinal member including an indicia located between the second cross bar and the second terminal end, the indicia indicating a distance of at least one of 6.5 inches and 10 inches from the first terminal end.

2. The device of claim 1 wherein the longitudinal member defines a first window between the second cross bar and the second terminal end, wherein the indicia is positioned adjacent the window so that a portion of the lacrosse head can be viewed through the window and compared to the indicia.

3. The device of claim 2 wherein the distance is 6.5 inches so that when the longitudinal member longitudinal axis is placed perpendicular to the longitudinal axis of the lacrosse head, a minimum dimension of a width of the lacrosse head can be evaluated by a user.

4. The device of claim 2 wherein the distance is 10 inches so that when the longitudinal member longitudinal axis is placed parallel to the longitudinal axis of the lacrosse head, a minimum dimension of a length of the lacrosse head can be evaluated by a user.

5. The device of claim 1 wherein the first and second portions of the first cross bar are pivotally joined with the longitudinal member so that the first and second portions rotate outward, away from the longitudinal axis, when transitioning from the collapsed mode to the extended mode.

6. The device of claim 1 comprising a third cross bar including a fifth portion and a sixth portion, each moveably joined with the longitudinal member distal from the first terminal end, the fifth portion terminating at a fifth end, the sixth portion terminating at a sixth opposing end, the fifth portion and the sixth portion moveable from a collapsed mode to an extended mode, the fifth portion and the sixth portion being at least partially disposed within the outer periphery of the longitudinal member in the collapsed mode so as to reduce the overall dimensions of the device, the fifth portion and the sixth portion extending beyond the outer periphery of the longitudinal member in the extended mode, the fifth and the sixth ends laying on a third transverse axis that is perpendicular to the longitudinal member longitudinal axis at 5 inches from the first terminal end, the fifth and sixth ends being at least one of 3.5 inches and 4 inches from one another in the extended mode.

7. The device of claim 1 wherein the first portion and second portion are of equal lengths, and project the same distance from the on opposite sides of the longitudinal member longitudinal axis.

8. The device of claim 1 wherein the longitudinal member includes a hinge disposed between first terminal end and the second terminal end, whereby hinge enables the longitudinal member to be reduced in length.

9. The device of claim 1 wherein the first terminal end includes a reference post extending from the longitudinal member, the reference post adapted to engage the throat of the lacrosse head.

10. A lacrosse head measurement device adapted to measure a lacrosse head having a throat, a scoop, a pair of opposing sidewalls, and a lacrosse head longitudinal axis, wherein an upper rim of the throat, the scoop and the pair of opposing sidewalls define a ball receiving portion, and wherein a lower rim of the throat, the scoop and the pair of opposing sidewalls define a ball retaining portion, the device comprising:
a longitudinal member including a longitudinal member longitudinal axis and a first terminal end adapted to contact the throat of the lacrosse head, the longitudinal member defining an outer periphery,
a first cross bar including a first portion and a second portion joined with the longitudinal member distal from the first terminal end, the first portion terminating at a first end, the second portion terminating at a second opposing end, the first and the second ends laying on a first transverse axis that is perpendicular to the longitudinal member longitudinal axis 1.25 inches from the first terminal end, the first and second ends spaced to determine whether the opposing sidewalls are located a minimum of 3 inches from one another along the first transverse axis; and
a second cross bar including a third portion and a fourth portion joined with the longitudinal member distal from the first terminal end, the third portion terminating at a third end, the fourth portion terminating at a fourth opposing end, the third and fourth ends laying on a second transverse axis that is perpendicular to the longitudinal member longitudinal axis 3 inches from the first terminal end, the third and fourth ends spaced to determine whether the opposing sidewalls are located a minimum of 3 inches from one another along the second transverse axis,
a third cross bar including a fifth portion and a sixth portion joined with the longitudinal member distal from the first terminal end, the fifth portion terminating at a fifth end, the sixth portion terminating at a sixth opposing end, the fifth and sixth ends laying on a third transverse axis that is perpendicular to the longitudinal member longitudinal axis 5 inches from the first terminal end, the fifth and sixth ends spaced to determine whether the opposing sidewalls are located a minimum of at least one of 4 inches and 3.5 inches from one another along the third transverse axis.

11. The device of claim 10 wherein the longitudinal member extends beyond the third cross bar and terminates at a second terminal end, the longitudinal member including an indicia located between the third cross bar and the second terminal end, the indicia indicating a distance of at least one of 6.5 inches and 10 inches from the first terminal end.

12. The device of claim 10 comprising a fourth cross bar including a seventh portion and an eighth portion joined with the longitudinal member distal from the first terminal end, the seventh portion terminating at a seventh end, the eighth portion terminating at an eighth opposing end, the seventh and eighth ends laying on a fourth transverse axis that is perpendicular to the longitudinal member longitudinal axis, the seventh and eighth ends spaced to determine whether the opposing sidewalls are located a minimum of at least one of 6.0 inches and 6.5 inches from one another along the fourth transverse axis.

13. The device of claim 12 wherein the longitudinal member extends beyond the third cross bar and terminates at a second terminal end, wherein the fourth cross bar is slidably joined with the longitudinal member between the third cross bar and the second terminal end so that the opposing sidewalls can be measured with the fourth cross bar at a plurality of locations.

14. The device of claim 12 wherein the longitudinal member defines an outside periphery, wherein the first, second and third cross bars are configurable in a collapsed mode and an extended mode, wherein the first, second and third cross bars are located substantially within the outside periphery when in the collapsed mode.

15. The device of claim 12 wherein the longitudinal member defines a first window and a second window distal from the first window, the first window including a first measurement indicia, the second window including a second measurement indicia.

16. The device of claim 12 wherein the longitudinal member includes a first member and a second member pivotally joined with one another so that a user can extend and collapse the longitudinal member, whereby the user can place the device in a pocket when the device is collapsed.

17. A lacrosse head measurement device adapted to measure a lacrosse head having a throat, a scoop, a pair of opposing sidewalls, and a lacrosse head longitudinal axis, wherein an upper rim of the throat, the scoop and the pair of opposing sidewalls define a ball receiving portion, and wherein a lower rim of the throat, the scoop and the pair of opposing sidewalls define a ball retaining portion, the device comprising:
a ball receiving sidewall width measuring portion adapted to measure the width along the ball receiving portion between the pair of opposing sidewalls at a plurality of predetermined distances from the throat; and
a ball retaining sidewall width measuring portion adapted to measure the width along the receiving portion between the pair of opposing sidewalls at a plurality of predetermined distances from the throat.

18. The device of claim 17 wherein the ball receiving sidewall measuring portion and the ball retaining sidewall widths measuring portion includes a plurality of cross bars movably joined with a longitudinal member, the plurality of cross bars adapted to move from an extended mode to a collapsed mode, whereby the device fits in the pocket of a user in the collapsed mode due to its reduced dimension relative to the extended mode.

19. The device of claim 18 wherein the longitudinal member includes first and second parts that move relative to one another from an extended mode to a collapsed mode, whereby the device fits in the pocket of a user in the collapsed mode due to its reduced dimension relative to the extended mode.

20. A method for determining whether a lacrosse head complies with proposed 2010 NCAA Rule 1.17, the method comprising:
(a) providing a lacrosse head having a throat, a scoop, a pair of opposing sidewalls, and a lacrosse head longitudinal axis, wherein an upper rim of the throat, the scoop and the pair of opposing sidewalls define a ball receiving portion, and wherein a lower rim of the throat, the scoop and the pair of opposing sidewalls define a ball retaining portion;
(b) providing a lacrosse head measurement device including:
a longitudinal member including a longitudinal member longitudinal axis and a first terminal end adapted to contact the throat of the lacrosse head,
a first cross bar including a first portion and a second portion, the first portion and the second portion moveably joined with the longitudinal member distal from the first terminal end, the first portion terminating at a first end, the second portion terminating at a second opposing end, and
a second cross bar including a third portion and a fourth portion, the third portion and the fourth portion moveably joined with the longitudinal member distal from the first terminal end, the third portion terminating at a third end, the fourth portion terminating at a fourth opposing end;
(c) moving the first and second portions of the first cross bar from a collapsed mode to an extended mode;
(d) moving the third and fourth portions of the second cross bar from a collapsed mode to an extended mode;
(e) engaging the first terminal end of the longitudinal member with the throat of the lacrosse head;
(f) aligning the longitudinal member longitudinal axis with the lacrosse head longitudinal axis; and
(g) perceiving whether at least one of the first end, second end, third end and fourth end contact an inner surface of each of the pair of sidewalls to determine whether the lacrosse head is compliant with proposed 2010 NCAA Rule 1.17.
